(19) United States
(12) Patent Application Publication
(10) Pub. No.: US 2020/0356747 A1
(43) Pub. Date: Nov. 12, 2020

(54) DISPLAY MODULE AND MOBILE TERMINAL

(71) Applicant: VIVO MOBILE COMMUNICATION CO., LTD., Chang'an Dongguan, Guangdong (CN)

(72) Inventor: Kaokao ZHANG, Chang'an Dongguan (CN)

(73) Assignee: VIVO MOBILE COMMUNICATION CO., LTD., Chang'an Dongguan, Guangdong (CN)

(21) Appl. No.: 16/766,273

(22) PCT Filed: Nov. 14, 2018
(86) PCT No.: PCT/CN2018/115398

§ 371 Date: May 21, 2020

(30) Foreign Application Priority Data
Nov. 30, 2017 (CN) 201711243216.0

(51) Int. Cl. G06K 9/00; G02F 1/1333; G02F 1/1335; G02F 1/163

(52) U.S. Cl. CPC G06K 9/0004; G02F 1/13338; G02F 1/133533; G02F 2001/1635; G02F 1/133305; G02F 1/163; G02F 1/133536

(57) ABSTRACT

A display module and a mobile terminal are provided. The display module includes: a screen cover plate, a fingerprint sensitive component, and a display component; the fingerprint sensitive component is arranged between the screen cover plate and the display component; the fingerprint sensitive component includes: an optical fingerprint sensitive layer made of transparent conductive material, a sensitive surface thereof having multiple pixels; the sensitive surface is attached to a surface of the screen cover plate, a attaching surface of the optical fingerprint sensitive layer is attached to a display surface of the display component; when the display component is on, the light emitted passes through the fingerprint sensitive component towards the screen cover plate, and is reflected to the sensitive surface by a finger pressed on the screen cover plate, the fingerprint sensitive component derives a pattern of a fingerprint from the amount of light received by pixels.

### CROSS-REFERENCE TO RELATED APPLICATION

The present application claims a priority to the Chinese patent application No. 201711243216.0 filed in China on Nov. 30, 2017, a disclosure of which is incorporated herein by reference in its entirety.

### TECHNICAL FIELD

The present disclosure relates to the field of mobile terminal technology, in particular to a display module and a mobile terminal.

### BACKGROUND

With the introduction of full-screen phones, mobile terminal displays can be further enlarged without changing the phone dimensions. To meet the requirement for a high screen-to-body ratio, the bottom bezel of mobile terminal display is removed; therefore the front-facing fingerprint recognition module formerly designed to be located at the bottom bezel cannot be kept at the same place and has to be moved to another place.

In the related art, there are two design schemes for fingerprint recognition module in mobile terminals with a high screen-to-body ratio: scheme 1, the fingerprint recognition module is arranged in the backside or side bezel of the mobile terminal; scheme 2: a fingerprint recognition area is defined on the screen, and the fingerprint recognition module is disposed underneath this fingerprint recognition area, wherein the fingerprint recognition module and the fingerprint recognition area are of the same size.

However, in scheme 1, performing fingerprint recognition at the backside or side bezel of a mobile terminal goes against the principle of ergonomics, causing poor user experience with regard to fingerprint recognition. While in scheme 2, fingerprint recognition can only be done at a fixed area on the screen, which cannot meet the requirement for full-screen fingerprint recognition in a high screen-to-body ratio mobile terminal.

### SUMMARY

According to a first aspect of the present disclosure, a display module is provided, which includes: a screen cover plate, a fingerprint sensitive component, and a display component; the fingerprint sensitive component is arranged between the screen cover plate and the display component; the fingerprint sensitive component includes: an optical fingerprint sensitive layer made of a transparent conductive material, and a sensitive surface of the optical fingerprint sensitive layer includes a plurality of pixels; the sensitive surface of the optical fingerprint sensitive layer is attached to a surface of the screen cover plate, an attaching surface of the optical fingerprint sensitive layer is attached to the display surface of the display component; when the display component is on, the light emitted by the display component passes through the fingerprint sensitive component towards the screen cover plate, part of the light is reflected to the sensitive surface of the optical fingerprint sensitive layer by a finger pressed on the screen cover plate, a pattern of a fingerprint is obtained according to an amount of light received by the pixels.

According to a second aspect of the present disclosure, a mobile terminal is provided, which includes a display module provided in the first aspect of the present disclosure.

### BRIEF DESCRIPTION OF THE DRAWINGS

The following briefly describes the accompanying drawings to be used in the description of the embodiments of the present disclosure, so as to elaborate the technical solutions more clearly. It is apparent the drawings in the following description are merely a part of the embodiments of the present disclosure. A person of ordinary skill in the art may obtain other drawings based on the drawings of the present disclosure without creative efforts.

FIG. 1 is a schematic structural diagram of a display module provided by the present disclosure;

FIG. 2 is a schematic diagram of an operation of a display module provided by some embodiments of the present disclosure;

FIG. 3 is a schematic structural diagram of a sensitive surface of an optical fingerprint sensitive layer provided by some embodiments of the present disclosure;

FIG. 4 is another schematic structural diagram of a display module provided by some embodiments of the present disclosure.

### DETAILED DESCRIPTION

The following describes clearly and completely the technical solutions according to the embodiments of the present disclosure with reference to the accompanying drawings in the embodiments of the present disclosure. It is apparent the embodiments in the following description are merely a part rather than all of the embodiments of the present disclosure. All other embodiments obtained by a person of ordinary skill in the art based on the embodiments of the present disclosure without creative efforts shall fall within the scope of the present disclosure.

The present disclosure provides a display module and a mobile terminal, to solve the problems in the related art that the requirement for full-screen fingerprint recognition in a high screen-to-body ratio mobile terminal cannot be met and poor user experience is caused.

Hereinafter, the display module and the mobile terminal provided in the present disclosure are explained in details with reference to several specific embodiments.

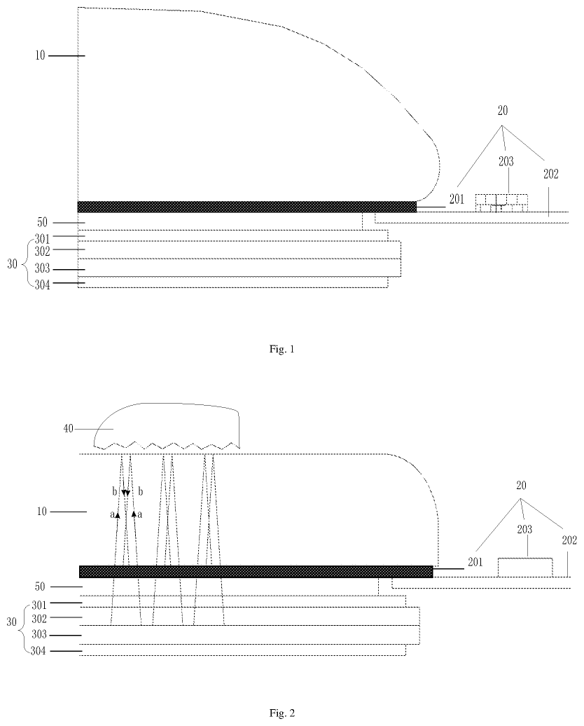

FIG. 1 depicts a schematic structural diagram of a display module provided in the present disclosure. The display module includes: a screen cover plate 10, a fingerprint sensitive component 20, and a display component 30; the fingerprint sensitive component 20 is arranged between the screen cover plate 10 and the display component 30; the fingerprint sensitive component 20 includes an optical fingerprint sensitive layer 201 which is made of a transparent conductive material, and a sensitive surface of the optical fingerprint sensitive layer includes a plurality of pixels; a sensitive surface of the optical fingerprint sensitive layer 201 is attached to a surface of the screen cover plate 10, a attaching surface of the optical fingerprint sensitive layer 201 is attached to a display surface of the display component 30.

In some embodiments of the present disclosure, the application scenarios of the display component 30 of the display module include but are not limited to active-matrix organic light emitting diode (AMOLED) displays and thin film transistor (TFT) displays. The largest difference between a TFT display and an AMOLED display is that the latter does not have a backlight panel.

Furthermore, the screen cover plate 10 can be made of glass or organic material, and may have a 2.5D/3D curved edge or a 2D flat edge. The embodiments of the disclosure do not set limits in this regard. The purpose of the screen cover plate 10 is to protect the fingerprint sensitive component 20 and the display component 30. Meanwhile, the images of the display component 30 are visible through the screen cover plate 10 as the screen cover plate 10 is transparent. In addition, the optical fingerprint sensitive layer 201 is made of a transparent conductive materials with good transmittance; and the sensitive surface of the optical fingerprint sensitive layer 201 includes a plurality of pixels arranged according to a preset rule, which are able to receive light and determine an amount of light. Therefore, when a finger is pressed on the screen cover plate 10, the light emitted by the display component 30 may impinge on the finger on the screen cover plate 10 and be reflected back to the pixels on the optical fingerprint sensitive layer 201.

Specifically, referring to FIG. 2, when the display component 30 is on, if a finger 40 is pressed on the screen cover plate 10 and the mobile terminal is performing a fingerprint verification operation, the light emitted by the display component 30 passes through the fingerprint sensitive component 20 towards the screen cover plate 10 in a direction a, and part of the light is reflected by the finger on the screen cover plate 10 to the sensitive surface of the optical fingerprint sensitive layer 201 in a direction b. A pattern of the fingerprint corresponding to the finger 40 is calculated by the fingerprint sensitive component 20 based on a difference of the amount of light received by the pixels and a preset amount of light. It should be noted that, to perform the fingerprint identification, the display component 30 must be on, i.e., the screen of mobile terminal is activated, otherwise, the screen must be activated before the verification can be performed.

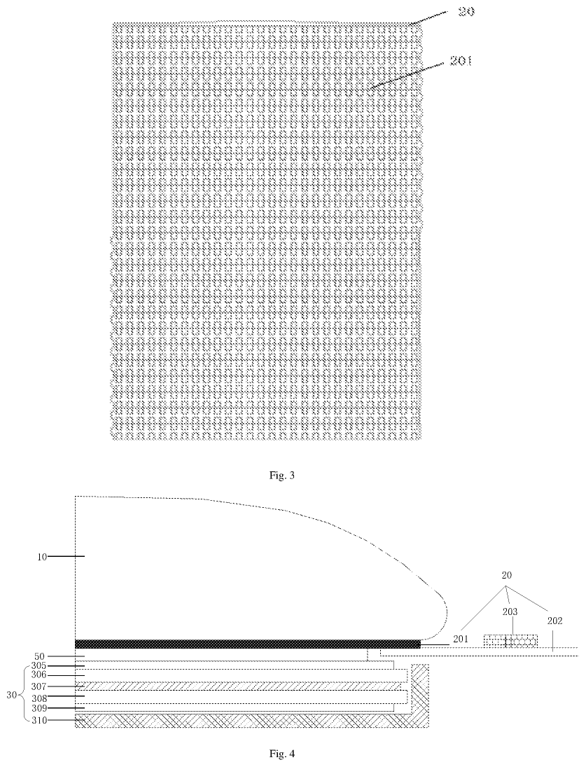

Additionally, FIG. 3 depicts a schematic structural diagram of the sensitive surface of an optical fingerprint sensitive layer provided in the present disclosure. A pattern of the sensitive surface of the optical fingerprint sensitive layer 201 is made of a transparent conductive material, such as an indium-tin-oxide material, and a manufacture principle thereof is similar to that of pixels in a display screen, i.e., a plurality of pixels 2011 are manufactured on the entire sensitive surface of the optical fingerprint sensitive layer 201 and each pixel 2011 is used to collect the light at a corresponding position. The pattern design may not be confined to that in FIG. 3, but suits the actual needs of applications. When a fingerprint verification is performed on the mobile terminal, part of the light is reflected towards the sensitive surface of the optical fingerprint sensitive layer 201 by the screen cover plate 10. When no finger is pressed on a surface of the screen cover plate 10, the amount of light received by each pixel 2011 on the sensitive surface is the same, which equals the preset amount of light. When a finger is pressed on the surface of the screen cover plate 10, the light is refracted by the uneven ridges and valleys on the surface of the finger at different angles and reflected back at different intensities, the pixels 2011 on the sensitive surface sense the variations of amount of light impinging on the corresponding positions, thus capturing the pattern of the fingerprint.

In summary, some embodiments in the present disclosure provide a display module, including: a screen cover plate, a fingerprint sensitive component, and a display component; the fingerprint sensitive component is arranged between the screen cover plate and the display component; the fingerprint sensitive component includes an optical fingerprint sensitive layer made of a transparent conductive material, and a sensitive surface of the optical fingerprint sensitive layer includes a plurality of pixels; the sensitive surface of the optical fingerprint sensitive layer is attached to a surface of the screen cover plate, the attaching surface of the optical fingerprint sensitive layer is attached to the display surface of the display component. When the display component is on, the light emitted by the display component passes through the fingerprint sensitive component towards the screen cover plate, part of the light is reflected to the sensitive surface of the optical fingerprint sensitive layer by a finger pressed on the screen cover plate. The fingerprint sensitive component derives the pattern of fingerprint by calculating based on a difference of the amount of light received by the pixels and a preset amount of light, therefore the requirement for full screen fingerprint identification on high screen-to-body ratio mobile terminal is met and user experience is improved.

Optionally, some embodiments of the present disclosure provide an fingerprint identification solution for a display module applied to an AMOLED display. Referring FIG. 3, the display component 30 includes: a first polarizer 301, an upper glass 302 and a lower glass 303. A surface of the first polarizer 301 is attached to the attaching surface of the optical fingerprint sensitive layer 201, the other surface of the first polarizer 301 is attached to a surface of the upper glass 302, the other surface of the upper glass 302 is attached to a surface of the lower glass 303, the upper glass 302 is used to protect the lower glass 303.

In the embodiments of the present disclosure, the first polarizer 301 is a type of polarizer, which is configured to filter natural light outside the mobile terminal to prevent the natural light from getting into the display component 30 to cause light interference that affects the operation of AMOLED displays. In addition, the upper glass 302 is made of encapsulation (ENCAP) glass and serves to protect the lower glass 303. The lower glass 303 is used to emit light and display images.

Optionally, a conductive circuit and a light-emitting layer are electroplated on a surface of the lower glass 303. The conductive circuit is connected to the light-emitting layer. When the conductive circuit is turned on, the light-emitting layer emits light at the screen cover plate 10. A very thin conductive circuit and a light-emitting layer are electroplated on the surface of the lower glass 303 facing the upper glass 302. The light-emitting layer is made of an organic small-molecule material, and may emit light when powered to serve as a display light source.

Optionally, referring to FIG. 1, the display component 30 further includes a pre-pressed foam 304 which is arranged on the other surface of the lower glass 303. The pre-pressed foam 304 is made of an elastic buffer material with good cushioning effect, so as to protect the other surface of the lower glass 303 and prevent it from being damaged under external force.

Optionally, some embodiments of the present disclosure provide a fingerprint identification solution for a display module applied to a TFT display. Referring to FIG. 4, the display component 30 includes a second polarizer 305, a color-filtering glass 306, a liquid crystal 307, a TFT glass 308, a third polarizer 309 and a backlight panel 310. The TFT glass 308 is configured to carry the liquid crystal 307; a surface of the second polarizer 305 is attached to the attaching surface of the optical fingerprint sensitive layer 201, the other surface of the second polarizer 305 is attached to a surface of the color-filtering glass 306, the other surface of the color-filtering glass 306 is attached to a surface of the TFT glass 308, the other surface of the TFT glass 308 is attached to a surface of the third polarizer 309, the other surface of the third polarizer 309 is attached to a light-emitting surface of the backlight panel 310.

In some embodiments of the present disclosure, the TFT glass 308 may include a plurality of TFTs, and each TFT is configured to carry part of the liquid crystal 307, such that each pixel of the liquid crystal 307 is driven by the TFT integrated behind the pixel. Therefore a TFT display is also a type of active matrix liquid crystal display device. The color-filtering glass 306 may provide three primary colors of red, green and blue and filter other colors to enable the rendition of different colors. The backlight panel 310 is configured to provide backlight and serve as the light source of the display component 30.

Optionally, the polarization direction of the second polarizer 305 is perpendicular to that of the third polarizer 309. The third polarizer 309 is configured to rotate the polarization direction of the light emitted by the backlight plate 310 by 90 degrees. Having passed through the liquid crystal 307 in the TFT glass 308, the polarized light undergoes further changes in polarization direction. Then the polarization direction of the light is further rotated by 90 degrees by means of the second polarizer 305, thereby converting the natural light emitted by the backlight plate 310 into polarized light for display.

Optionally, referring to FIG. 1 and FIG. 4, the fingerprint sensitive component further includes: a flexible circuit board 202 and an optical fingerprint integrated circuit (IC) 203; an end of the flexible circuit board 202 is connected to the optical fingerprint sensitive layer 201, the other end of the flexible circuit board 202 is connected to the optical fingerprint integrated circuit 203.

In some embodiments of the present disclosure, the flexible circuit board 202 is configured to transmit the fingerprint data collected by the optical fingerprint sensitive layer 201, while the optical fingerprint integrated circuit 203 is configured to process and match the fingerprint data, to determine whether the fingerprint data match with that in a preset fingerprint database.

Optionally, referring to FIG. 1 and FIG. 4, the display module further includes: a photoresist layer 50 arranged between the attaching surface of the optical fingerprint sensitive layer 201 and the display surface of the display component 30. The photoresist is an adhesive with good light transmittance and used to bond the fingerprint sensitive component 20 and the display component 30.

Optionally, the optical fingerprint sensitive layer 201 is made of transparent indium tin oxide (ITO). In chemistry, the indium tin oxide is a nanoscale metal oxide of indium and tin. The indium tin oxide has good conductivity and transparency, and can block harmful electron radiation, ultraviolet rays and far infrared rays. Therefore, ITO is usually sprayed on glass, plastic and electronic display screens to serve as a transparent conductive film while reducing the harmful electron radiation. Since the optical fingerprint sensitive layer 201 is made of transparent ITO, the conductivity of the optical fingerprint sensitive layer 201 can be guaranteed, and the light transmittance of the optical fingerprint sensitive layer 201 is improved.

Some embodiments of the present disclosure further provide a mobile terminal including the display module in the embodiments of the present disclosure. The mobile terminal may be a mobile terminal such as a mobile phone, or a tablet computer.

In summary, some embodiments in the present disclosure provide a display module and a mobile terminal. The display module includes a screen cover plate, a fingerprint sensitive component and a display component. The fingerprint sensitive component is arranged between the screen cover plate and the display component, the fingerprint sensitive component includes an optical fingerprint sensitive layer made of a transparent conductive material, and a sensitive surface of the optical fingerprint sensitive layer includes a plurality of pixels. The sensitive surface of the optical fingerprint sensitive layer is attached to a surface of the screen cover plate, and the attaching surface of the optical fingerprint sensitive layer is attached to the display surface of the display component. When the display component is on, the light emitted by the display component passes through the fingerprint sensitive component towards the screen cover plate, and part of the light is reflected to the sensitive surface of the optical fingerprint sensitive layer by the finger pressed on the screen cover plate. The fingerprint sensitive component derives the pattern of fingerprint by calculating based on a difference of the amount of light received by the pixels and a preset amount of light, therefore the requirement for full screen fingerprint identification on high screen-to-body ratio mobile terminal is met and user experience is improved.

It should be understood by those skilled in the art that, for convenience and simplicity of description, for details of the above mentioned systems, devises and units, references may be made to the corresponding processes in the foregoing method embodiment, and a repeated description is omitted herein.

The above are merely optional embodiments of the present disclosure, but the present disclosure is not limited thereto. Any modifications, equivalent replacements and improvements made within the principles of the present disclosure shall also fall within the scope of the present disclosure.

The foregoing descriptions are merely specific embodiments of the disclosure, and the scope of the disclosure is by no means limited thereto. Any modifications or replacements that would easily occurred to those skilled in the art, without departing from the technical scope disclosed in the disclosure, should be encompassed in the scope of the present disclosure. Therefore, the scope of the present disclosure is to be determined by the scope of the claims.

1. A display module applied to a mobile terminal, comprising:
a screen cover plate, a fingerprint sensitive component and a display component; wherein,
the fingerprint sensitive component is arranged between the screen cover plate and the display component;
the fingerprint sensitive component comprises an optical fingerprint sensitive layer made of a transparent conductive material, and a sensitive surface of the optical fingerprint sensitive layer comprises a plurality of pixels;
the sensitive surface of the optical fingerprint sensitive layer is attached to a surface of the screen cover plate, and a attaching surface of the optical fingerprint sensitive layer is attached to a display surface of the display component;
when the display component is on, light emitted by the display component passes through the fingerprint sensitive component towards the screen cover plate, part of the light is reflected to the sensitive surface of the optical fingerprint sensitive layer by a finger pressed on the screen cover plate, and a pattern of a fingerprint is obtained according to an amount of light received by the pixels.

2. The display module according to claim 1, wherein the display component comprises:
a first polarizer, an upper glass and a lower glass,
a surface of the first polarizer is attached to the attaching surface of the optical fingerprint sensitive layer, an other surface of the first polarizer is attached to a surface of the upper glass, and an other surface of the upper glass is attached to a surface of the lower glass.

3. The display module according to claim 2, wherein
the surface of the lower glass is electroplated with a conductive circuit and a light-emitting layer;
the conductive circuit is connected to the light-emitting layer.

4. The display module according to claim 3, wherein the display component further comprises:
a pre-pressed foam arranged on an other surface of the lower glass.

5. The display module according to claim 1, wherein the display component comprises:
a second polarizer, a color-filtering glass, a liquid crystal, a thin film transistor (TFT) glass, a third polarizer and a backlight panel,
the TFT glass is configured to carry the liquid crystal;
a surface of the second polarizer is attached to the attaching surface of the optical fingerprint sensitive layer, an other surface of the second polarizer is attached to a surface of the color-filtering glass, an other surface of the color-filtering glass is attached to a surface of the TFT glass, an other surface of the TFT glass is attached to a surface of the third polarizer, an other surface of the third polarizer is attached to a light-emitting surface of the backlight panel.

6. The display module according to claim 5, wherein
a polarization direction of the second polarizer is perpendicular to a polarization direction of the third polarizer.

7. The display module according to claim 1, wherein the fingerprint sensitive component further comprises:
a flexible circuit board and an optical fingerprint integrated circuit;
an end of the flexible circuit board is connected to the optical fingerprint sensitive layer;
an other end of the flexible circuit board is connected to the optical fingerprint integrated circuit.

8. The display module according to claim 1, further comprising:
a photoresist layer, arranged between the attaching surface of the optical fingerprint sensitive layer and the display surface of the display component.

9. The display module according to claim 1, wherein
the optical fingerprint sensitive layer is made of transparent indium tin oxide.

10. A mobile terminal, comprising the display module according to claim 1.

11. The mobile terminal according to claim 10, comprising a mobile phone or a tablet computer.

12. A mobile terminal, comprising the display module according to claim 2.

13. A mobile terminal, comprising the display module according to claim 3.

14. A mobile terminal, comprising the display module according to claim 4.

15. A mobile terminal, comprising the display module according to claim 5.

16. A mobile terminal, comprising the display module according to claim 6.

17. A mobile terminal, comprising the display module according to claim 7.

18. A mobile terminal, comprising the display module according to claim 8.

19. A mobile terminal, comprising the display module according to claim 9.
